(19) United States
(12) Patent Application Publication
(10) Pub. No.: US 2014/0262994 A1
(43) Pub. Date: Sep. 18, 2014

(54) WATER FILTER CARTRIDGE INTERFACE

(71) Applicant: GENERAL ELECTRIC COMPANY, SCHENECTADY, NY (US)

(72) Inventor: Timothy Scott Shaffer, LaGrange, KY (US)

(21) Appl. No.: 13/800,441

(22) Filed: Mar. 13, 2013

(51) Int. Cl. B01D 35/30; B01D 29/92

(52) U.S. Cl. CPC B01D 35/30; B01D 29/92
USPC 210/136; 210/232

(57) ABSTRACT

An apparatus includes an interlocking member being disposed radially outward of a portion of the apparatus, wherein the interlocking member comprises a tapered helical interface following an outwardly tapering helical path on an annular outer wall of the interlocking member and including at least one depression defined thereon.

### BACKGROUND

The subject matter disclosed herein relates generally to water filtration, and more particularly to water filter cartridges and the like.

Water filters are used to extract contaminants such as chlorine, chloramine, volatile organic compounds (VOCs), lead, microbes and other undesirable substances. The presence of some such contaminants is a direct result of agricultural chemicals, industrial and municipal wastewater facility processes, water treatment and disinfection byproducts, urban runoff and/or naturally occurring sources in ground water supplies. Others contaminants are introduced after treatment processes within the home and/or municipal sources, for example, from piping and contact with contaminant items.

Household filters can generally be broken into two classes: Point of Entry (POE) filters and Point of Use (POU) filters. POE filters are placed at the entry point of water into the home and continuously filter all water that enters the home. POU filters are installed in areas such as kitchen sinks and refrigerators where water may be used for direct consumption.

A water filter system includes inlet/outlet tubing, a manifold and a filter component. The manifold receives untreated water, directs the water into a filter media, which subsequently directs the treated/filtered water back out for use. The filter media can vary depending on the contaminants targeted for removal. Sediment filters will take out fairly coarse particulate matter greater than 10 microns. Carbon filters, which generally include 60-70% carbon, 2-5% scavenger additives such as titantium dioxide, and 25-50% polyethylene binder dust, will extract contaminants such as chlorine, lead, VOCs, pharmaceuticals, particulates larger than 0.5 microns, and some large microbes such as cysts. The scavenger additives are included to shore-up the block's ability to remove those contaminants that carbon does not have an affinity to adsorb such as heavy metals like lead. Hollow fiber technology, ozone, ultraviolet (UV) lamps and quaternary technologies are also used to extract or destroy microbes, which can be as small as 0.015 microns. In virtually all cases, the filter media will be exhausted over time and use and need to be replaced in order to restore the system's ability to remove contaminants.

The filter media can be housed and attached to the manifold in two common manners. The primary approach is to have a removable media item that can be pulled from a pressure shell that encompasses the media when fastened to the manifold. Such an approach requires that water supply into the manifold be secured to avoid water loss and heavy spray during the removal of the pressure shell. An alternative approach is to fully encapsulate the filter media with a pressure vessel typically in the form of canister. The manifold will include a check valve within its incoming flow path, and when the canister is fully installed into the manifold, the check valve will be dislodged from a closed position to a position that allows flow to bypass the check valve.

There are multiple ways that a canister in fully encapsulated systems is engaged into the manifold. One method includes screwing the canister into the manifold. Many times, a quarter turn revolution is used to fully engage the canister, as this allows the canister to be installed in two different configurations (front and back). In existing approaches, a helical shoulder or thread of constant diameter is provided in the cap of the canister and a reciprocal helical shoulder or thread of constant diameter is provided in manifold. To ensure a proper engagement with the check valve features during installation into a constant diameter helical thread, the initial fit into the manifold can be quite tight, making it difficult to initially start the installation. Accordingly, there is a need to develop a more ergonomic configuration for engaging a canister into a manifold with a quarter turn straight helical interface.

With improving filter cartridge technology, new filtration systems can achieve the required level of contaminant removal using higher flow rates than older systems. However, use of the older cartridges in the new higher flow rate systems could result in the filter cartridge not performing at its rated removal level because of the system flow rate is higher than that for which the cartridge was designed. Similarly, the useful life of the cartridge militates against use of older lower flow rate cartridges in the new higher flow rate systems. For example, if an older filter rated to have a useful flow through life of approximately 125 gallons when operated at a flow rate of 0.5 gallons per minute (gpm) were to be placed into a newer system that may operate at a flow rate of 0.75 gpm, at that higher flow rate its expected life would be only 75 gallons. To avoid the underperformance resulting from use of older style cartridges in the newer systems, the cartridge manifold interfaces in the newer systems are designed to prevent the insertion of older style cartridges in the new manifolds.

The features added within a new system to prevent the use of old cartridges with the new system tend to also preclude use of new cartridges into the older systems. However, it can be advantageous to enable new replacement filter cartridges to be capable of being installed into manifolds of older systems as well as newer, enhanced flow systems. For example, if a new high flow rate cartridge were to be installed in an older/existing manifold, at the lower flow rate of the older system, the life of the cartridge can actually be extended such that a cartridge rated at 125 gallon at 0.75 gpm would actually last 200 gallons when used in a system with a flow rate of 0.5 gpm. In such situations, while older systems will not fully utilize the enhanced capabilities of the newer cartridges, the newer cartridges will perform at least at the old system levels. So, having new cartridges that are compatible with the older system would avoid the need to provide separate cartridge models.

### BRIEF DESCRIPTION OF EXAMPLE EMBODIMENTS OF THE INVENTION

As described herein, the exemplary embodiments of the present invention overcome one or more disadvantages known in the art.

One aspect of the invention relates to a filter cartridge apparatus that includes a filter canister having a filter media structure assembly and at least one channel for directing a flow of fluid, and an interlocking member being disposed radially outward of a portion of the apparatus, wherein the interlocking member comprises a tapered helical interface following an outwardly tapering helical path on an annular outer wall of the interlocking member and including at least one depression defined thereon.

Another aspect relates to an apparatus as described in the aspect of the invention above operably fluidly coupled to a fluid filtration system comprising a manifold comprising a cartridge receiving portion, a manifold inlet port and a manifold outlet port, a check valve being disposed for fluidly sealing at least one of said ports, a flow inlet channel leading to the check valve, the manifold inlet port being operably fluidly coupled to a fluid source for receiving a flow of fluid and to a flow inlet channel, the manifold outlet port being fluidly coupled to a flow outlet channel; and a filter cartridge comprising a filter canister, a filter media structure assembly received in said canister, and an interlocking member being disposed radially outward of a portion of the canister wherein the interlocking member comprises a tapered helical interface following an outwardly tapering helical path on an annular outer wall of the interlocking member.

In accordance with another aspect the tapered helical canister interface includes at least two discrete ridges and wherein the depression is formed by the gap between adjacent ridges. In one configuration, the manifold protrusion projects from the raised shoulder in a radial direction, and in another, the protrusion projects from the raised shoulder in an axial direction.

These and other aspects and advantages of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. Moreover, the drawings are not necessarily drawn to scale and, unless otherwise indicated, they are merely intended to conceptually illustrate the structures and procedures described herein.

### BRIEF DESCRIPTION OF THE DRAWINGS

In the drawings:

FIG. 1 illustrates a water filter apparatus, in accordance with a non-limiting exemplary embodiment of the invention;

FIG. 2 illustrates components of a water filter apparatus, in accordance with a non-limiting exemplary embodiment of the invention;

FIG. 3 illustrates components of a filter canister, in accordance with a non-limiting exemplary embodiment of the invention;

FIG. 4 illustrates a cross-section view of a water filter apparatus, in accordance with a non-limiting exemplary embodiment of the invention;

FIG. 5 illustrates a cross-section view of an uninstalled position and installed position of a manifold and filter canister, in accordance with a non-limiting exemplary embodiment of the invention;

FIG. 6 illustrates a side view image of a bayonet, in accordance with a non-limiting exemplary embodiment of the invention;

FIG. 7 illustrates exploded and cross-section views of the filter canister cap and insert component, in accordance with a non-limiting exemplary embodiment of the invention;

FIGS. 8A-B illustrate various views of the filter canister cap in accordance with non-limiting embodiments of the invention;

FIGS. 9A-D illustrate cut-away views of a manifold alone and in combination with a filter canister cap in accordance with non-limiting exemplary embodiments of the invention;

FIGS. 10A-C illustrate views of a filter canister cap, a manifold alone, and a manifold in combination with a filter canister cap in accordance with non-limiting exemplary embodiments of the invention; and

FIG. 11 illustrates a manifold shoulder engaged with a filter cap shoulder, in accordance with a non-limiting exemplary embodiment of the invention.

### DETAILED DESCRIPTION OF EXAMPLE EMBODIMENTS OF THE INVENTION

As described herein, one or more embodiments of the invention include helical and discrete interlocking features for a water filter apparatus.

FIG. 1 illustrates a water filter apparatus 120, in accordance with a non-limiting exemplary embodiment of the invention. Individual components that constitute water filter apparatus 120 are depicted in the subsequent figures, and the individual components illustrated therein (as well as the numerical labels corresponding thereto) are used herein in describing one or more embodiments of the invention.

Accordingly, FIG. 2 presents components of the water filter apparatus 120 of FIG. 1, in accordance with a non-limiting exemplary embodiment of the invention. By way of illustration, FIG. 2 depicts a filter canister 102, o-rings 104, a bayonet 106, a check valve 108, a manifold body 110, o-ring 112 and o-ring 114, and speed-fit cap 116 and speed-fit cap 118. As shown in FIG. 2, the filter canister 102 additionally includes an annular canister interlocking member 190. Additionally, the manifold body 110 includes a manifold inlet port 152 and manifold outlet port 150. These components are discussed in further detail herein.

FIG. 3 illustrates components of the filter canister 102, in accordance with a non-limiting exemplary embodiment of the invention. By way of illustration, FIG. 3 depicts a filter canister cap 130 and an insert component 132, which comprise the annular canister interlocking member 190. In at least one embodiment of the invention, the annular canister interlocking member 190 can include a compression seal (such as, for example, in the form of an o-ring 204 as depicted in FIG. 5 and FIG. 7) positioned on the inner surface of the member 190. Additionally, in at least one embodiment of the invention, the insert component 132 enables various methods of engaging the check valve 108. The engagement amount of the check valve 108 can vary from, for example, 0.050 inches to 0.1875 inches depending on how far the check valve is to be pushed up. In an example embodiment, a 1/16″ diameter o-ring can be pushed around the check valve 108 up almost 1/16″ to break seal. Additional embodiments can include pushing higher (0 to 0.125″) to facilitate higher flow rates if desired or needed. Accordingly, in at least one embodiment of the invention, the check valve 108 engages the insert component 132 upon rotation of the filter canister 102 upon an approximately quarter turn of the filter canister 102, opening a passage-way through which fluid can pass.

FIG. 3 also depicts a media adapter cap 180 and a filter media structure assembly 134. As known in the art, the filter media structure assembly 134 can include one of multiple compositions. For example, the filter media structure assembly 134 can include carbon, a reverse osmosis membrane, an ultra-filtration component (such as a hollow fiber cartridge), etc. Additionally, as depicted in FIG. 3, the filter canister 102 can include a polypropylene canister portion 136 and a soft touch santoprene canister portion 138.

Also, at least one embodiment of the invention includes attaching a canister to a water filter head assembly, including, for example, adding an elastomeric seal component (such as, for example, o-ring 204 as depicted in FIG. 5 and FIG. 7) to the mating surface provided by the inner periphery of the annular canister interlocking member 190 to sealingly engage the external cylindrical surface of the inlet boss portion (depicted as component 508 in FIG. 6) of the bayonet 106 as the filter canister 102 is installed.

FIG. 4 illustrates a cross-section view of water filter apparatus 120, in accordance with a non-limiting exemplary embodiment of the invention. Specifically, FIG. 4 shows manifold body 110, bayonet 106, a flow inlet channel 456 defined within the manifold body 110 leading to the check valve 108, as additionally depicted in FIG. 6 and FIG. 9A, and a flow outlet channel 458 defined in the manifold body 110. The manifold inlet port 152 is operably fluidly coupled to a fluid source for receiving a flow of unfiltered fluid, and is also fluidly coupled to the flow inlet channel 456. The manifold outlet port 150 is fluidly coupled to flow outlet channel 458.

FIG. 4 also shows filter canister cap 130, insert component 132, media adapter cap 180, and the filter media structure assembly 134, which includes a central bore media structure 407. As is known in the art, there are commonly two different filter media structure assembly types—carbon blocks and hollow fiber. The hollow fiber includes a plastic outer shell that contains the hollow fiber into a bundle. This bundle is potted in the shell such that water passes from outside the fibers into the center of individual fibers, where it flows through the fiber to a common outlet atop the cartridge. The insert component 132 (or in one or more embodiments, the filter canister cap 130) includes a centrally located hole or channel on the horizontal surface that acts to locate the filter media structure assembly 134 radially within the filter canister 102 and direct fluid thereto. The upwardly extending cylindrical portion of the media adapter cap 180 fits into the centrally located hole in insert component 132 to locate the media. Further, the media adapter cap 180 can be a portion of the filter media structure assembly 134 or coupled to the filter media structure assembly 134 as a separate component.

As noted above, new filters are being engineered to extract more contaminants at higher flow rates due to changes in both the media and filter geometry. By way of example, cartridges filled with hollow fiber media can be capable of removing bacterial and viral microorganisms down to a 15 nanometer size. Another media, as mentioned, includes a traditional carbon block, where the surface area has been increased by almost 50% but volume correspondingly only by approximately 20%.

FIG. 5 presents an image representing the uninstalled position 302 and installed position 304 of the manifold body 110 and filter canister 102, in accordance with a non-limiting exemplary embodiment of the invention. In addition to the components also depicted in FIG. 4, FIG. 5 illustrates a helical shoulder flange 1252 on the manifold body 110 and a corresponding complementary or reciprocal helical flange 1254 on the filter canister cap 130. Rotation of the flange 1254 on the filter canister cap 130 with respect to the manifold flange 1252 on the manifold body 110 acts to engage the filter canister 102 and the manifold body 110 and draw them together in an axial direction into a tight fit. Additionally, FIG. 5 identifies o-ring 204, which is described further in connection with FIG. 7. Moreover, the uninstalled position 302 and installed position 304 of the manifold body 110 and filter canister 102 depicted in FIG. 5 illustrate how the bayonet 106 fits into the filter canister 102 and more specifically how inlet boss (depicted as component 508 in FIG. 6) of the bayonet 106 is received in sealing engagement with a first mating surface provided in this embodiment by an interior annular surface 660 of interlocking member 190, which is formed by the inner surface of the side wall of filter canister cap 130 together with the upwardly extending outer rim 132c of insert component 132, as further illustrated in FIG. 7.

Additionally, FIG. 5 depicts how outlet boss 506 (as further detailed in FIG. 6) is received into the inlet annular recess defined in this embodiment by the hollow cylindrical interior 182 of media adapter cap 180 and seals off against a second mating surface illustratively embodied by the interior surface of the upwardly extending cylindrical sidewall of the media adapter cap 180.

FIG. 6 illustrates a side view image of bayonet 106. As described herein, bayonet 106 is a protrusion that comes down off of the bottom of the manifold body 110 for sealing engagement with the filter canister 102. As noted, the bayonet 106 can, by way of example, be welded via ultrasonic, spin, or heat-stake means into the manifold body 110, thereby establishing a water flow path. The smaller diameter portion, also referred to herein as an outlet boss 506 of the bayonet 106, which includes annular spaces 520 for fitting o-rings 104 if desired, fits into the hollow cylindrical interior 182 of media adapter cap 180 in the middle of filter canister 102 to form a seal therebetween. By way of illustration, FIG. 4 depicts a double o-ring seal engaging the media adapter cap 180 of the filter media structure assembly 134, wherein the o-rings (such as depicted as components 104 in FIG. 2) squeeze into the media adapter cap 180 to form a seal.

The fluid exiting the filter travels up through the flow outlet channel 458 (as depicted in FIG. 4) in the middle of the bayonet 106 and is ultimately directed out of the manifold body 110. The seal between outlet boss 506 and the filter canister 102 prevents the water exiting the filter canister 102 from leaking around outlet boss 506. The larger diameter portion, also referred to herein as an inlet projection or inlet boss 508 of the bayonet 106, provides a surface for sealingly engaging the filter canister 102 and more particularly for sealingly engaging a mating surface provided in this embodiment by an interior annular surface 660 of interlocking member 190, which is formed by the inner surface of the side wall of the filter canister cap 130 together with the outer rim 132c of insert component 132, as hereinafter more fully described in reference to FIG. 7, to prevent the unfiltered fluid entering the filter canister 102 through the check valve 108 from leaking to the ambient environment outside of the manifold body 110.

As described and depicted herein, bayonet 106 includes the flow inlet channel 456 (as depicted in FIG. 4) around check valve 108 having a discharge opening 556 for discharging the fluid conveyed therein to the filter canister 102. The discharge opening 556 is defined in a lower margin of depending inlet boss 508. The inlet boss 508 has a circular cross section defined about a longitudinal axis and a circumferential outer margin. The discharge opening 556 is radially displaced from the longitudinal axis. Boss sealing means can include o-rings positioned in annular space 522 to seal the space between the inlet boss 508 and the inner periphery of the filter canister cap 130 when fully assembled. Additionally, an outlet opening 558 is fluidly coupled to the flow outlet channel 458. Further, the flow outlet channel 458 fluidly couples the outlet opening 558 to the manifold outlet port 150.

Accordingly, the bayonet 106 receives fluid flow from the manifold inlet port 152 in the manifold body 110. The bayonet 106 distributes the flow into the inlet boss 508 to the discharge opening 556 defined in the lower margin of the bayonet 106. Further, as is known in the art, structural support features above the discharge opening 556 can be provided to align and guide the movement of the check valve 108 along the longitudinal axis of the discharge opening 556.

As noted above and further described in the remaining figures, when engaged with the filter canister 102, the large diameter cylinder or inlet boss 508 provides a sealing surface for engagement with a first mating surface provided by an interior annular surface 660 of interlocking member 190, which is formed by the inner surface of the side wall of cap 130 together with the upwardly extending rim 132c of insert component 132, to provide a seal between the incoming, unfiltered fluid and ambient environment. The smaller diameter cylinder or outlet boss 506, when engaged with the filter canister 102, fits and forms a seal against cylindrical interior 182 of media adapter cap 180 and directs filtered fluid toward the exit of the manifold body 110. Each of these bayonet cylinders may, merely by way of example, include an o-ring or a set of o-rings as well as a set of glands to facilitate a proper seal.

On the bottom horizontal surface of the inlet boss 508, a plunger of the check valve 108 protrudes downward and is biased into this position via a mechanical spring within the check valve 108. This plunger is depressed upward as it engages a complementary surface on the filter canister 102 when the filter canister 102 is being installed in the manifold body 110, which surface may comprise recessed sumps or raised protrusions, depending on orientation of the check valve 108, as is known in the art.

FIG. 7 illustrates exploded and cross-section views of the filter canister cap 130 and insert component 132. Additionally, FIG. 7 depicts the annular canister interlocking member 190, including the interior annular surface 660 of interlocking member 190, which comprises a first mating surface as detailed herein. Further, FIG. 7 depicts an o-ring groove 670 for receiving and retaining o-ring 204. The groove 670 is formed, in the embodiment illustrated in FIG. 7, in the first mating surface formed by the upper edge of rim 132c on the insert component 132 and the inner bottom annular surface 130a on the filter canister cap 130 proximate the intersection of the filter canister cap 130 and insert component 132. Additionally, the insert component 132, in at least one embodiment of the invention, is spun welded into the filter canister cap 130. In an example embodiment, the o-ring 204 sealingly engages the vertical walls of the inlet boss 508 of the bayonet 106 during installation in lieu of and/or conjunction with an existing o-ring installed on the outlet boss 506 of the bayonet 106. Specifically, as detailed herein, boss sealing means of the bayonet 106 include o-rings 104 positioned in annular spaces 520 to seal the space between the outlet boss 506 and the second mating surface, provided in the embodiments herein described by the inner periphery of the filter canister cap 130, when fully assembled.

FIG. 7 also depicts an annular recess 1258 formed by the upper facing surface 132a of the insert component 132, extending between inner upwardly extending rim 132b and outer upwardly extended rim 132c, as well as slot features 680 located around the inner hole of the insert component 132. In at least one embodiment of the invention, fluid entering via discharge opening 556 in inlet boss 508 travels into the inlet recess 1258 between the bayonet 106 and the surface 132a of the insert component 132 into the interior space between the filter canister cap 130 and the exterior surface of the media adapter cap 180, through the slot features 680 located around the central hole in the insert component 132. From this region the water flows into the space between the filter media structural assembly 134 and the cylindrical wall of canister 102 and then radially inwardly through filter media structure assembly 134 to the central bore media structure 407 of the filter media structural assembly 134 and exits the canister 102 through the central opening in cap 180 to outlet channel 458 of manifold 110 which passes through outlet boss 506.

As noted above, conventionally the interface between the canister and the manifold involves a straight or constant diameter helical shoulder formed in the cap of the canister and a reciprocal straight helical shoulder is formed on the manifold. The initial fit into the manifold can be quite tight making it difficult to initially start the installation. In accordance with the present invention initial engagement is made easier by adding a taper to the helical shoulder flanges (such as denoted by element 1254 in FIG. 7) formed in the filter canister cap wall (such as denoted by element 1250 in FIG. 7), such that the diameter measured to the outer edge of the shoulder decreases from a maximum diameter at the base of the filter canister cap 130 to a minimum diameter proximate the opposite end of the filter canister cap 130. This provides a relatively small diameter toward the top of the cap and a relatively large diameter at the base. As the canister 102 is rotated into the stationary manifold, the gap between the filter canister cap's shoulder flange perimeter and the inner wall of the manifold body 110 starts relatively large and then decreases or tightens as the base of the filter canister cap 130 is pulled into the manifold body 110. As best seen in FIGS. 8A and 8B, in the illustrative embodiment, the pair of helical shoulder flanges 1254a and 1254b which extend radially outward from the filter canister cap 130 are formed with a taper relative to the longitudinal center axis of the filter canister cap 130. In at least one embodiment of the invention, the degree of taper, a, is on the order of eight degrees. However, a taper in the range of two to fifteen degrees, could be employed depending on other parameters of the system components. The limits on the taper are primarily a function of the shoulder width, the helical pitch, the filter canister cap inner diameter and the diameter of the manifold sleeve. In an embodiment, the taper should be the steepest achievable within the constraints of the system. In the illustrative embodiment, for compatibility with current manifolds, a taper on the order of 8 degrees can be implemented without structurally compromising the cap wall.

As illustrated in FIG. 9A, the shoulder flange 1252 on the inner wall of the receiving cylinder of the manifold 110 follows a reciprocal helical path of similar pitch, but without a taper. Accordingly, in such an embodiment of the invention, as the filter canister 102 is rotated into the stationary manifold body 110, the gap between the perimeter of filter canister cap flanges 1254a and 1254b and the inner wall 604 of the manifold body 110 decreases/tightens as the filter canister cap 130 is rotated into the manifold body 110. By way of example, the tapered helical path of the flanges 1254a and 1254b on the filter canister cap 130 can allow the filter canister cap wall diameter to be kept below 1.55 inches, enabling a fit and function with older, looser fitting manifold sections as well as newer manifold models.

FIG. 9A illustrates a cut-away view of manifold body 110, in accordance with a non-limiting exemplary embodiment of the invention. FIG. 9A includes bayonet 106, along with check valve 108 (positioned in the flow inlet channel 456; not expressly identified in this view) and an outlet ball valve 650 (positioned in the flow outlet channel 458; not expressly identified in this view). In the embodiment of FIG. 9A, shoulder flange 1252 follows a constant diameter or un-tapered helical path on the inner annular wall 604 of the manifold body 110. Alternatively, the inner diameter of the reciprocal shoulders on the interior of the manifold body 110 could be provided with a complementary taper, for example by increasing the thickness of the manifold wall in spiral fashion to provide a tighter fit through the manifold engagement.

In the illustrative embodiments herein described, the thread pitch of the interlocking helical shoulders is on the order of 0.8 threads per inch. Helical interfaces tend to back out when under pressure, particularly when the thread pitch is above 0.25 threads per inch. To counter this tendency to back out, the filter canister cap 130 and the manifold body 110 are configured to provide additional interfering engagement therebetween to supplement the resistance provided by friction between the engaging shoulder surfaces.

In accordance with the embodiment illustrated in FIG. 9A, a retaining protrusion 606 is disposed on the inner annular wall 604 of manifold body 110 and projects radially inwardly therefrom. The retaining protrusion 606, as further described herein, engages the filter canister cap 130 to facilitate interlocking the manifold body 110 to the filter canister 102.

In the embodiments of FIGS. 7 and 8B (as well as 9B), the shoulders 1254a and 1254b on the filter canister cap 130 comprise a set of discrete adjacent ridges 752, each adjacent pair defining therebetween a slot or gap 754 (also referred to herein as a shoulder depression). The series of discrete ridges 752 and gaps/slots 754 enable interfering engagement with raised protrusion 606 projecting radially inwardly from the inner annular wall 604 of the manifold body 110 which fits or snaps into the slot 754 between adjacent ridges 752 as the filter canister 102 is rotated into the manifold body 110 to oppose the tendency of the filter canister 102 to back out when under pressure. In an alternative to the radial interference provided by the raised protrusion 606, illustrated in FIGS. 9C and 9D, an axial interference is provided by a protrusion 616, disposed on the upper surface of each of shoulders 1254a and 1254b which projects upwardly or axially in a direction parallel to the longitudinal axis of the manifold. As best seen in FIG. 9D, protrusion 616 fits or snaps into the slot 754 between adjacent ridges 752.

In each of these embodiments, the shape of the gap or slot forming the depression for receiving the protrusion, and the shape and height of the protrusion needs to be sufficient to satisfactorily resist backing out, without presenting excessive resistance to the rotation for insertion. In the illustrative embodiments heights on the order of 0.05 inches with simple radial shaped protrusions and rectangular slots have provided satisfactory performance. However, other shapes of depressions and protrusions could be similarly employed.

Additionally, at least one embodiment of the invention includes locking or further engaging the filter canister 102 into the manifold 110 using a raised protrusion on the underside of the flange 1254 and a corresponding depression or notch on the top side of the manifold shoulder flange 1252.

FIGS. 10A-C illustrate views of a filter canister cap 130, a manifold body 110 alone, and a manifold body 110 in combination with a filter canister cap 130 in accordance with non-limiting exemplary embodiments of the invention. As illustrated in FIGS. 10A-C, an embodiment of the invention includes a series of three slots disposed on the outer cap flange, as opposed to the embodiment illustrated, for example, in FIGS. 8B and 9B which includes rectangular slots encompassing a majority of the circumference of the outer cap flange. In the embodiment depicted in FIGS. 10A-C, the slots (that is, the series of three slots) are all opening up in a direction parallel to one another. As best seen in FIG. 10A, in this embodiment, a pair of a series of three distinct ridges 752a are disposed on the shoulders 1254a and 1254b, and the shoulders 1254a and 1254b are positioned 180 degrees relative to each other about the canister axial axis and each flange revolves around the filter canister cap 130 with an angle β, which in the illustrative embodiments is approximately 200 degrees as compared to an angle on the order of 160 degrees found in certain commercially available canister caps. The wider angle β provided by the slightly overlapping shoulders increases the arc length of the shoulders and improves the extent of engagement with the inner wall 604 of the manifold body 110, as shown in FIGS. 10B and 10C. Accordingly, radial interference is provided by protrusion 606 is disposed on the inner annular wall 604 of manifold body 110 and projects radially inwardly therefrom. Also, each adjacent pair of ridges in each set of ridges 752a defines therebetween a slot or gap 754a (also referred to herein as a shoulder depression). The series of discrete ridges 752a and gaps/slots 754a in the embodiment depicted in FIGS. 10A-C enable interfering engagement with the raised protrusion 606 projecting radially inwardly from the inner annular wall 604 of the manifold body 110 which fits or snaps into the slot a 754a between a pair of adjacent ridges from sets 752a as the filter canister 102 is rotated into the manifold body 110 to oppose the tendency of the filter canister 102 to back out when under pressure.

FIG. 11 illustrates manifold flange 1252 engaged with canister cap flange 1254, in accordance with a non-limiting exemplary embodiment of the invention. Specifically, the downward protrusion 1102 defined on the underside of the flange 1254 on the filter canister cap 130 is captured by the depression 1002 defined in the shoulder flange 1252 of the manifold body 110, locking the filter canister 102 into place (inserted in the manifold body 110). Such engagement can occur, for example, upon rotating the filter canister cap 130 of the filter canister 102 into the manifold body 110.

Accordingly, while there have shown and described and pointed out fundamental novel features of the invention as applied to exemplary embodiments thereof, it will be understood that various omissions and substitutions and changes in the form and details of the devices illustrated, and in their operation, may be made by those skilled in the art without departing from the spirit of the invention. Moreover, it is expressly intended that all combinations of those elements and/or method steps which perform substantially the same function in substantially the same way to achieve the same results are within the scope of the invention. Furthermore, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A filter cartridge apparatus comprising:
a filter canister having a filter media structure assembly and at least one channel for directing a flow of fluid; and
an interlocking member being disposed radially outward of a portion of the apparatus, wherein the interlocking member comprises a tapered helical interface following an outwardly tapering helical path on an annular outer wall of the interlocking member and including at least one depression defined thereon.

2. The apparatus of claim 1, wherein the tapered helical interface comprises a taper of between approximately two degrees and approximately fifteen degrees.

3. The apparatus of claim 1, wherein the tapered helical interface comprises a taper of approximately eight degrees.

4. The apparatus of claim 1, wherein the tapered helical interface comprises a protrusion displaced on an underside surface thereof.

5. The apparatus of claim 1, wherein the tapered helical interface comprises two raised shoulders disposed approximately 180 degrees relative to each other about a longitudinal axis of the filter canister.

6. The apparatus of claim 5, wherein each of the two raised shoulders revolves around the canister approximately 200 degrees.

7. A fluid filtration system comprising:
a manifold comprising a cartridge receiving portion, a manifold inlet port and a manifold outlet port, a check valve being disposed for fluidly sealing at least one of the manifold inlet port and the manifold outlet port, and a flow inlet channel leading to the check valve, wherein the manifold inlet port is operably fluidly coupled to a fluid source for receiving a flow of fluid and to the flow inlet channel, and wherein the manifold outlet port is fluidly coupled to a flow outlet channel; and
a filter cartridge comprising a filter canister, a filter media structure assembly received in said filter canister, and an interlocking member being disposed radially outward of a portion of the filter canister, wherein the interlocking member comprises a tapered helical interface following an outwardly tapering helical path on an annular outer wall of the interlocking member.

8. The system of claim 7, wherein the tapered helical interface comprises a taper of between approximately two degrees and approximately fifteen degrees.

9. The system of claim 7, wherein the tapered helical interface comprises a taper of approximately eight degrees.

10. The system of claim 7, wherein the tapered helical interface comprises at least one depression defined thereon.

11. The system of claim 7, wherein the tapered helical interface comprises two raised shoulders disposed approximately 180 degrees relative to each other about a longitudinal axis of the filter canister.

12. The system of claim 11, wherein each of the two raised shoulders extends around the filter canister approximately 200 degrees.

13. The system of claim 7, wherein the cartridge receiving portion comprises cylindrical wall, with a raised shoulder formed on the inner surface thereof, and wherein the raised shoulder follows a taper-less reciprocal helical path of similar pitch to the tapered helical interface of the interlocking member.

14. The system of claim 13, further comprising a retaining protrusion disposed on the raised shoulder of the cartridge receiving portion.

15. The system of claim 14, wherein the retaining protrusion interferingly engages a depression formed in the interlocking member to facilitate interlocking the manifold to the filter canister.

16. The system of claim 15, wherein the tapered helical interface includes at least two discrete ridges and wherein the depression is formed by a gap between adjacent ridges.

17. The system of claim 16 wherein the protrusion projects from the raised shoulder in a radial direction.

18. The system of claim 16 wherein the protrusion projects from the raised shoulder in an axial direction.

19. The system of claim 13, further comprising a depression incorporated into the raised shoulder of the cartridge receiving portion.

20. The system of claim 19, wherein the depression incorporated into the raised shoulder of the cartridge receiving portion captures a protrusion projecting from an underside of the raised shoulder of the tapered helical interface of the interlocking member.
